(19) United States
(12) Patent Application Publication
(10) Pub. No.: US 2018/0202754 A1
(43) Pub. Date: Jul. 19, 2018

(54) Self Defense Instrument and Key with Sharpened Tip

(71) Applicant: Blase Patrick Dillingham, Jr., (US)

(72) Inventor: Blase Patrick Dillingham, JR., South Lake Tahoe, CA (US)

(21) Appl. No.: 15/837,213

(22) Filed: Dec. 11, 2017

Related U.S. Application Data
(60) Provisional application No. 62/433,116, filed on Dec. 12, 2016.

(51) Int. Cl. F41B 15/00; E05B 19/00; A47G 29/10

(52) U.S. Cl. CPC F41B 15/00; A47G 29/10; E05B 19/00

(57) ABSTRACT

The present invention is a self-defense instrument comprised of an ergonomic key holder and a key with a sharpened tip that is retained within a slotted compartment defined within the key holder, said key holder further including opposite extending protrusions that extend generally perpendicularly away from the slotted compartment and that are configured to be graspable by the user's hand.

### CROSS-REFERENCE TO RELATED APPLICATION

This application claims the benefit of and priority to U.S. Provisional Patent Application No. 62/433,116 filed on Dec. 12, 2016, which is incorporated by reference herein in its entirety.

### FIELD OF THE INVENTION

The present invention is in the technical field of key holders in combination with the technical field of utility tools. More particularly, the inventions relate to such key holders that are capable of being used in self-defense and as a utility tool.

### BACKGROUND OF THE INVENTION

Conventional keys are ergonomically hard to hold between the fingers in a manner that would allow for use to fend off an attacker. Additionally, a key is generally blunt therefore has limited effectiveness as a self-defense instrument or deterrent. Recently, the development of the ‘concealed carry’ movement has brought on a whole new industry. One of the major components of this industry is key holders and pocket tools. Even more, these key holders hold tools that are the shape of keys but do not function as keys. These tools come in all shapes and sizes and can be placed on a key ring or key holder. But they do to function as a key and cannot open a door. There are currently no keys on the market or in the patent registry that offer a real functional key that is also provides a sharpened tip and therefor has a dual use.

### SUMMARY OF THE INVENTION

The present invention is a personal self-defense instrument made up of two parts. First is a key, either blank or cut, with a sharpened tip. Second is an ergonomic device to hold a key so the key can fit comfortable between the user's fingers. This invention can be used as a self-defense device or as a utility tool like a small prybar.

### BRIEF DESCRIPTION OF THE DRAWINGS

FIG. 1 is a perspective view of a key blank with a sharpened tip of the present invention;

FIG. 2 is a side view of the key blank with a sharpened tip of FIG. 1;

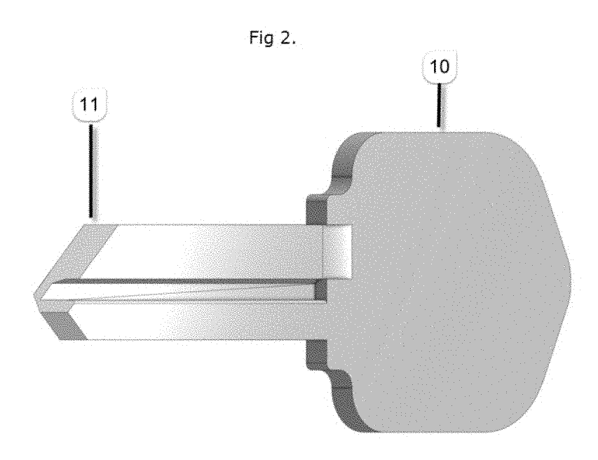

FIG. 3 is a side view of the key holder of the present invention.

FIG. 4 is a top view of the key holder of FIG. 3.

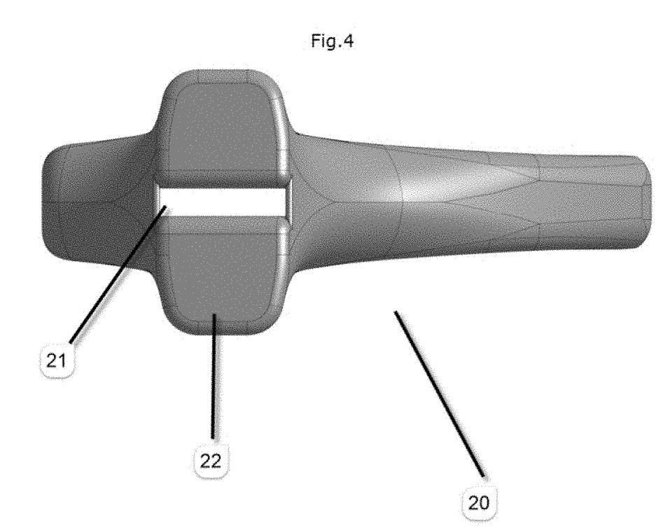

FIG. 5 is a perspective view of the key holder of FIG. 3.

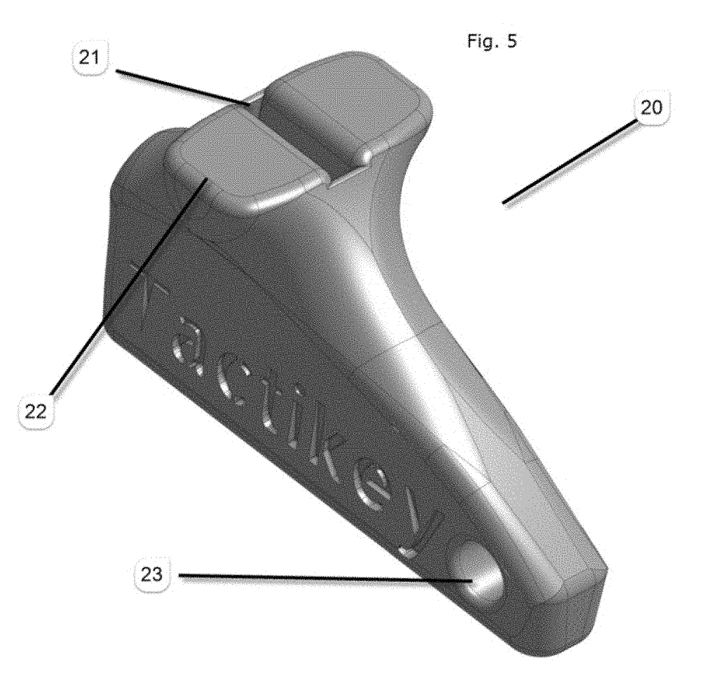

FIG. 6 is a perspective view of the key holder of FIG. 3.

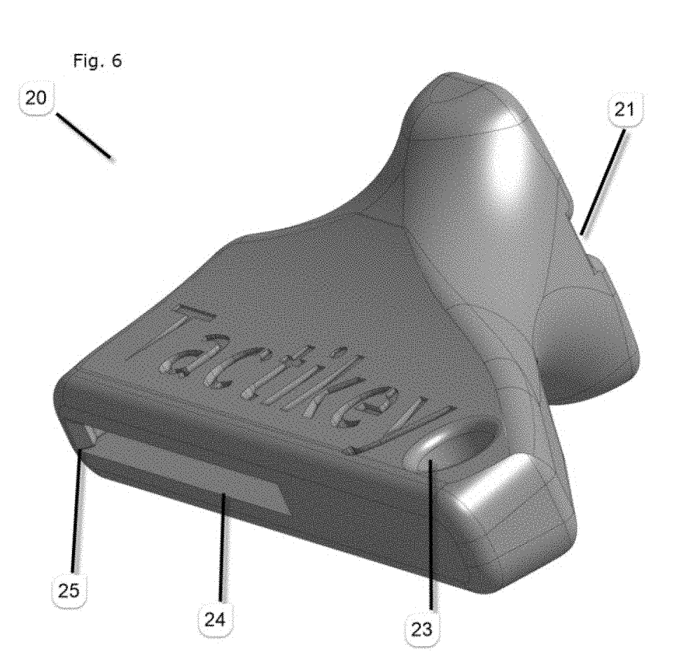

FIG. 7 is a perspective view of the key holder of FIG. 3.

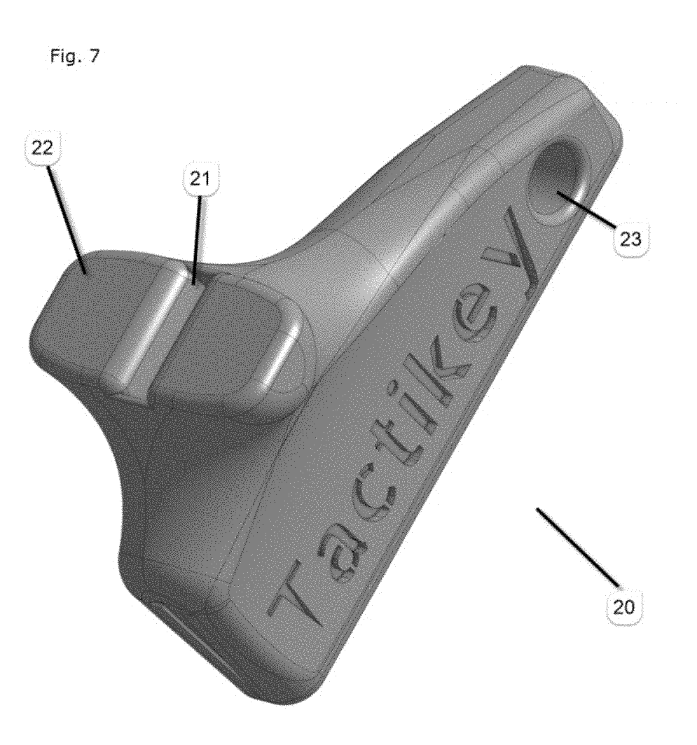

FIG. 8 is a perspective view of sharpened key blank of FIG. 1, in combination with key holder of FIG. 3.

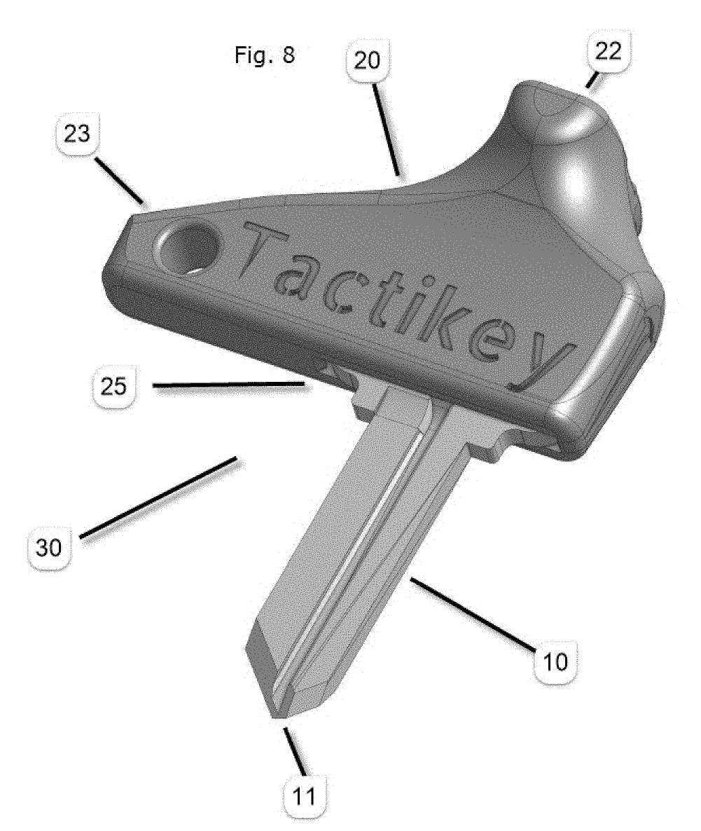

FIG. 9 is a perspective view of key with a sharpened tip of FIG. 1 in combination with key holder of FIG. 3, held in a closed hand.

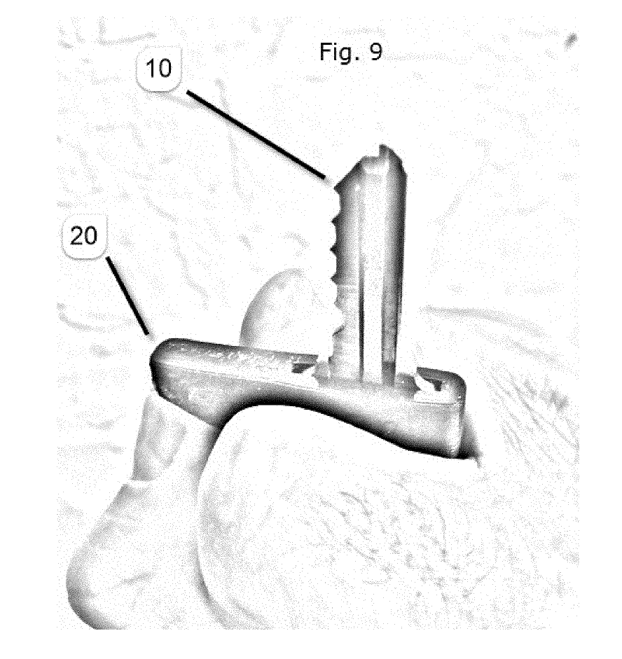

FIG. 10 is a perspective view of key with a sharpened tip of FIG. 1 in combination with key holder of FIG. 3, held in a partially opened hand.

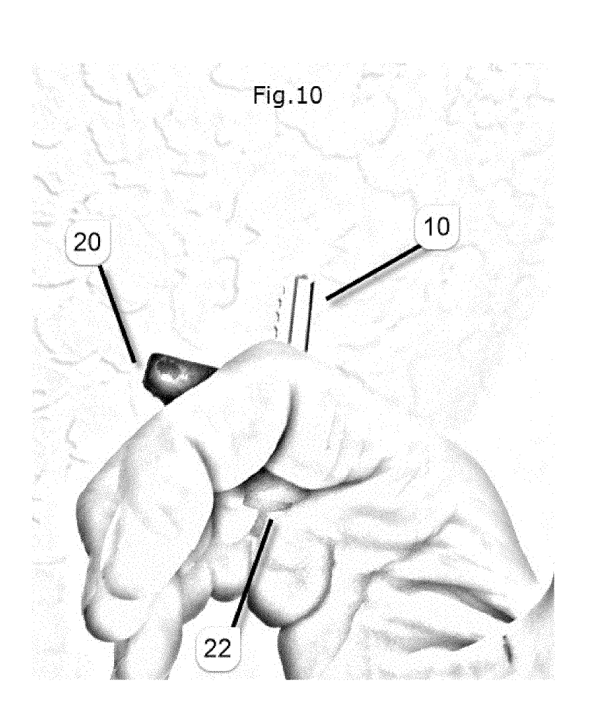

FIG. 11 is a perspective view of key with a sharpened tip of FIG. 1 in combination with key holder of FIG. 3, and held in a closed hand.

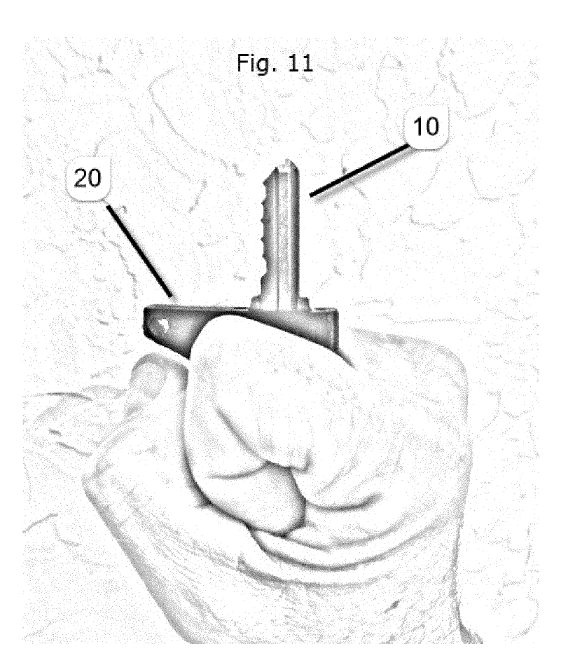

FIG. 12 is an exploded perspective view of key holder of FIG. 3.

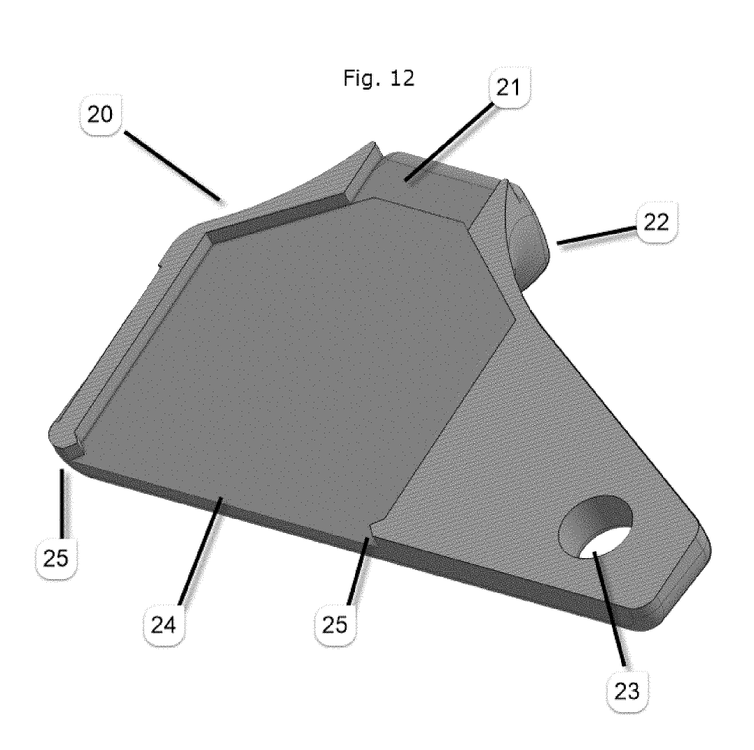

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

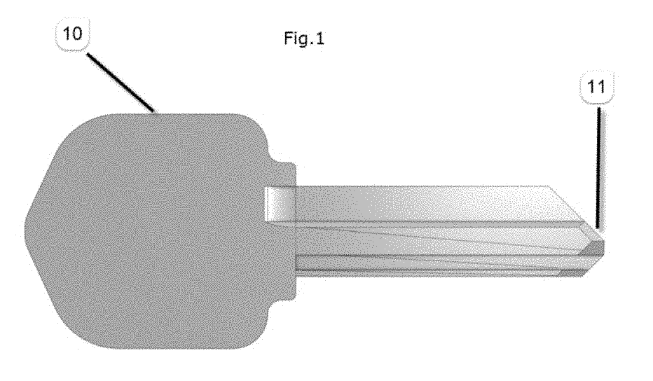

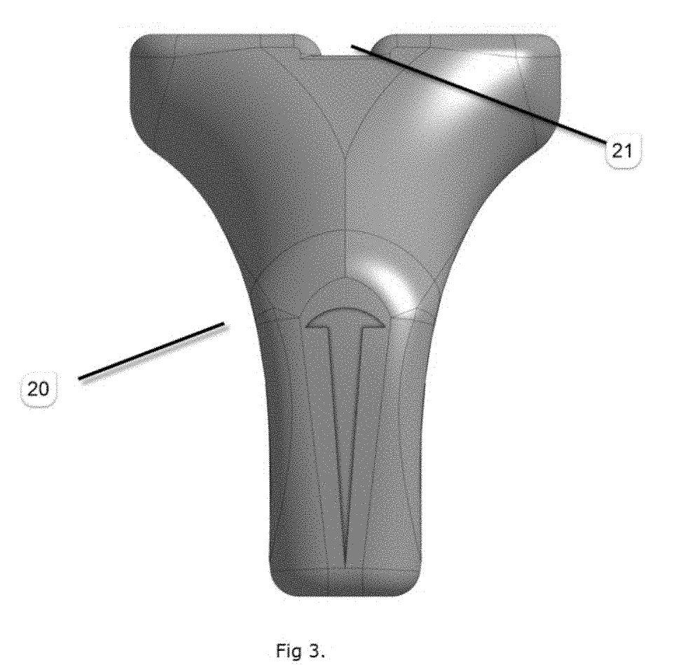

Referring now to the invention in more detail, in FIG. 1 there is shown a key blank 10, with a sharpened tip 11. Referring now to the invention in more detail, in FIG. 1 there is shown a key blank 10, having sharpened tip 11, configured in a specific way. Referring now to the invention in more detail in FIG. 3 there is shown a key holder 20, about 1.5 to 2 inches long and about 1 inch tall and about 1 inch wide, though not restricted to those exact measurements. It is small enough to fit in the palm of a hand and big enough to grip comfortably and securely.

In more detail, still referring to the invention of FIG. 3, the key holder 20, has a flat spot on the top 22, for stability when gripped between the fingers. There is a narrow rectangular hole 21, in the flat spot 22. This hole 21, is where an additional key tip is inserted to push the key securely within the holder 20, out. The key holder 20, has a circular hole 23, in the end, where a key ring can be attached without affecting the user's grip on the key holder 20. On the bottom of the key holder 20, there is a narrow slot 24, where a key head or bow is secured within the key holder 20. Within this narrow slot 24, there are two small triangular protrusions 25, on each side of the opening, to hold the key securely within the key holder 20.

When key 10, from FIG. 1, is inserted into key holder 20, from FIG. 3, they work together to make a system, FIG. 30. This invention is a key with sharpened tip 10, held in a secure device, key holder 20, in a comfortable manner to defend oneself. The key holder 20, is sufficiently wide enough to fit comfortably in a closed hand in an ergonomic fashion with a key with sharpened tip 10, protruding through the fingers. This key holder 20, also provides a convenient and comfortable way to carry one's keys.

The key with sharpened tip 10, can be constructed out of titanium, brass, steel, aluminum or any other sufficiently rigid and strong material such as high-strength plastic or metal. The key holder 20, can be constructed out of any kind of plastic, metal or any other sufficiently rigid and strong material such as high-strength plastic or metal.

The advantages of the present invention include, without limitation, that it is portable and exceedingly easy to transport. It can allow the user to fend off an attacker similar to a knife. It is easy to hold and it is relatively small and lightweight. Further, the devices generally will store a house key on a keychain in a safe and efficient way. Further, the devices can provide a feeling of security while carrying around an object that everyone is always carrying around with them all the time.

In broad embodiment, the present invention is a self-defense device consisting of a key with a sharpened tip and an ergonomic holder for a key. They can work separately or in combination.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim the following:

1. A self-defense instrument that is comprised of a key holder and a key with a sharpened tip that is retained within a slotted compartment defined within the key holder, said key holder further including opposite extending protrusions that extend generally perpendicularly away from the slotted compartment and that are configured to be graspable by the user's hand.

2. A slotted compartment in the key holder will encapsulate the head of a key tightly within the key holder in a locked and secure position.

3. An ergonomic key holder that fits comfortable in the palm of one's hand with a closed fist.

4. A key with sharpened tip.

5. The sharpened key can be use independently of the key holder, and key holder can be used independently of the sharpened key, for example, with any standard unsharpened key.

6. Key is still fully functional and can still be used to open doors and locks.
